(19) United States
(12) Patent Application Publication
(10) Pub. No.: US 2024/0170731 A1
(43) Pub. Date: May 23, 2024

(54) SECONDARY BATTERY AND METHOD OF MANUFACTURING THE SAME

(71) Applicant: MURATA MANUFACTURING CO., LTD., Kyoto (JP)

(72) Inventor: Yasuo GOKITA, Kyoto (JP)

(21) Appl. No.: 18/428,038

(22) Filed: Jan. 31, 2024

Related U.S. Application Data
(63) Continuation of application No. PCT/JP2022/036431, filed on Sep. 29, 2022.

(30) Foreign Application Priority Data
Oct. 1, 2021 (JP) 2021-162795

(51) Int. Cl. H01M 10/0587; H01M 10/0525

(52) U.S. Cl. CPC H01M 10/0587; H01M 10/0525

(57) ABSTRACT

Provided is a secondary battery including an electrode wound body that has an electrode-constituting layer wound, where the electrode-constituting layer includes a positive electrode, a negative electrode, and a separator disposed between the positive electrode and the negative electrode. The electrode wound body has a central cavity extending at the center along a winding axis, and one electrode of the positive electrode and the negative electrode includes, at an end surface of the electrode wound body, a current collecting foil extending part where a current collector extends outward from the other electrode. The current collecting foil extending part in the vicinity of the central cavity is bent so as to be folded back toward the central cavity, and the electrode-constituting layer is shifted from the end surface to an internal side of the electrode wound body.

### CROSS REFERENCE TO RELATED APPLICATIONS

The present application is a continuation of PCT patent application no. PCT/JP2022/036431, filed on Sep. 29, 2022, which claims priority to Japanese patent application no. 2021-162795, filed on Oct. 1, 2021, the entire contents of which are incorporated herein by reference.

### BACKGROUND

The present disclosure relates to a secondary battery and a method for manufacturing the secondary battery.

Secondary batteries can be repeatedly charged and discharged, and are used in various applications. For example, secondary batteries are used for mobile devices such as mobile phones, smart phones, and laptop computers.

### SUMMARY

The present disclosure relates to a secondary battery and a method for manufacturing the secondary battery.

A secondary battery is disclosed in which a current collector is welded to a foil-shaped body at an end of an electrode plate in an electrode wound body.

For such a secondary battery, a foil-shaped body is subjected to shaping processing by high-frequency vibration, and the current collector is welded to the shaped foil-shaped body. By using high-frequency vibration at the time of shaping processing, the foil-shaped body at the electrode plate is softened and shaped such that foil-shaped bodies are entangled with each other.

As for such shaping processing, the foil-shaped body compressed by the high-frequency vibration can cause a disadvantageous phenomenon in the electrode wound body. For example, at the time of compressing the foil-shaped body, there is a possibility that the compressed foil-shaped body will enter a central cavity of the electrode wound body, thereby causing the electrodes come into contact with each other and then cause a short circuit.

The present disclosure relates to providing, in an embodiment, a secondary battery that has a more preferred structure in terms of short circuit prevention, and a method for manufacturing the secondary battery.

A secondary battery according to the present disclosure, in an embodiment, includes an electrode wound body that has an electrode-constituting layer wound, with the electrode-constituting layer including a positive electrode, a negative electrode, and a separator disposed between the positive electrode and the negative electrode, the electrode wound body has a central cavity extending at the center along a winding axis, one electrode of the positive electrode and the negative electrode includes, at an end surface of the electrode wound body, a current collecting foil extending part where a current collector extends outward from the other electrode, the current collecting foil extending part in the vicinity of the central cavity is bent so as to be folded back toward the central cavity, and the electrode-constituting layer is shifted from the end surface to an internal side of the electrode wound body.

In addition, a method for manufacturing a secondary battery is provided and includes, in an embodiment, a step of winding an electrode-constituting layer including a positive electrode, a negative electrode, and a separator disposed between the positive electrode and the negative electrode to form an electrode wound body while leaving a central cavity; and a step of shaping an end surface of the electrode wound body, the step of forming the electrode wound body includes: winding the electrode-constituting layer with a current collector extending part of one of the positive electrode and the negative electrode extending outward from the other electrode at the end surface; and winding the electrode-constituting layer such that the electrode-constituting layer is shifted from the end surface to an internal side of the electrode wound body in the vicinity of the central cavity, and the shaping step includes bending the current collecting foil extending part in the vicinity of the central cavity so as to be folded back.

The secondary battery according to the present disclosure has a more preferred structure in terms of short circuit prevention according to an embodiment.

For example, at the end surface of the electrode wound body, one electrode of the positive electrode and the negative electrode includes the current collector extending part where the current collector extends outward from the other electrode. The current collector extending part has a shape bent so as to be folded back toward the central cavity provided at the center of the electrode wound body. The electrode-constituting layer located in the vicinity of the central cavity is disposed so as to be shifted into the internal side from the end surface of the electrode wound body. With such a structure, the bent current collector extending part and the electrode-constituting layer are separated from each other in the vicinity of the central cavity, thereby allowing a short circuit in the electrode wound body to be more suitably prevented.

In addition, in the method for manufacturing a secondary battery according to an embodiment of the present disclosure, in the step of forming the electrode wound body, the electrode-constituting layer constituting the vicinity of the central cavity is wound so as to be shifted toward the internal side of the electrode wound body, with the current collector extending part of one electrode extending from the end surface of the electrode wound body. Then, in the shaping step, the current collector extending part is bent to shape the end surface of the electrode wound body. The above-described steps allow the current collector extending part and the electrode-constituting layer to be separated from each other, thereby providing a secondary battery capable of more suitably preventing a short circuit.

### BRIEF DESCRIPTION OF THE FIGURES

FIG. 1 is a schematic sectional view exemplarily illustrating an electrode-constituting layer.

FIG. 2 is a schematic perspective view illustrating an appearance of an example of a secondary battery according to an embodiment of the present disclosure.

FIG. 3 is a schematic sectional view of the secondary battery in FIG. 2 in a section passing through a winding axis P along a line A-A as viewed in an arrow direction.

FIG. 4 is a schematic perspective view illustrating an electrode wound body constituting a secondary battery according to an embodiment of the present disclosure.

FIG. 5 is a schematic sectional enlarged view of a part of the electrode wound body in the vicinity of the center thereof in FIG. 4 in a section along B-B as viewed in the arrow direction.

FIG. 6 is a schematic view for illustrating constituent members of an electrode wound body constituting a secondary battery according to an embodiment of the present disclosure.

FIG. 7 is a schematic perspective view for illustrating a winding aspect of an electrode wound body according to an embodiment of the present disclosure.

FIG. 8 is a schematic perspective view illustrating an electrode wound body wound according to an embodiment of the present disclosure.

FIG. 9 is a schematic sectional view of the electrode wound body in the vicinity of the center thereof in FIG. 8 in a section along a line C-C as viewed in the arrow direction.

FIG. 10 is a schematic sectional enlarged view illustrating a part of an electrode wound body wound according to an embodiment of the present disclosure in the vicinity of the center thereof.

FIG. 11 is a schematic view illustrating constituent members of an electrode wound body according to an embodiment of the present disclosure.

FIG. 12 is a schematic plan view for illustrating end face shaping according to an embodiment of the present disclosure.

### DETAILED DESCRIPTION

Hereinafter, a secondary battery according to an embodiment of the present disclosure will be described in more detail. Although the description will be made with reference to the drawings as necessary, various elements in the drawings are merely schematically and exemplarily illustrated for understanding of the present disclosure, and the appearance, the dimensional ratio, or the like can be different from those of an actual secondary battery.

The “vertical direction” and “horizontal direction” described directly or indirectly in the present specification correspond to the vertical direction and horizontal direction in the drawings. In addition, the “sectional view” described directly or indirectly in the present specification is based on a virtual section obtained by cutting the secondary battery in a direction along the winding axis of the electrode wound body constituting the secondary battery or in a direction perpendicular to the winding axis. In addition, the “plan view” used in the present specification is based on a sketch drawing in the case of an object viewed from the upper side or the lower side in the direction of the winding axis. Unless otherwise specified, the same reference signs or symbols denote the same members or sites, or the same semantic contents.

In addition, “perpendicular to the winding axis” and “substantial perpendicular” as used in the present specification do not necessarily have to be complete “perpendicular”, and include aspects slightly deviated therefrom (for example, the angle formed with the winding axis within a range of 90°±20°, for example, within a range of 90°±10°).

In addition, “substantial parallel” as used in the present specification does not necessarily have to be complete “parallel”, and includes aspects slightly deviated therefrom (for example, ranges from perfect parallel to ±20°, such as ±10°).

The term “secondary battery” as used in the present specification refers to a battery that can be repeatedly charged and discharged. Accordingly, the secondary battery according to the present disclosure is not excessively limited by its name, and for example, a power storage device and the like can also be included in the subject of the present disclosure.

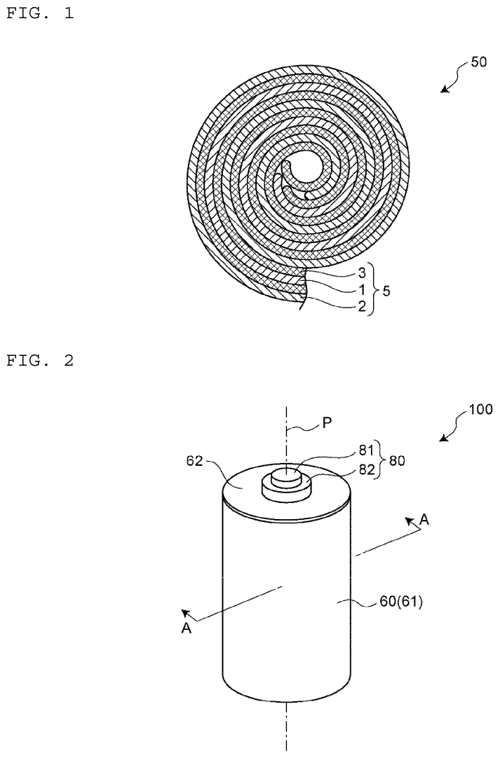

FIG. 1 shows a schematic sectional view of an exemplary electrode wound body 50. The secondary battery according to the present disclosure includes the electrode wound body 50 including an electrode-constituting layer 5 including a positive electrode 1, a negative electrode 2, and a separator 3. As illustrated, the electrode wound body 50 may have a wound structure in which the electrode-constituting layer 5 is wound in a wound form. More specifically, the electrode wound body 50 may have a wound structure in which the electrode-constituting layer 5 extending relatively long in a band or elongated form including the positive electrode 1, the negative electrode 2, and the separator 3 disposed between the positive electrode 1 and the negative electrode 2 are wound in a roll form. For the secondary battery according to the present disclosure, such an electrode wound body 50 is enclosed together with an electrolyte (for example, a non-aqueous electrolyte) in an exterior body.

The positive electrode 1 is composed of at least a positive electrode material layer 12 and a positive electrode current collector 11 (see FIG. 5). For the positive electrode 1, the positive electrode material layer is provided on at least one side of the positive electrode current collector, and the positive electrode material layer includes a positive electrode active material as an electrode active material. For example, for the positive electrode in the electrode wound body, the positive electrode material layer may be provided on both sides of the positive electrode current collector, or may be provided on only one side of the positive electrode current collector. The positive electrode current collector does not necessarily have to have, on both sides thereof or on the whole surface of one side thereof, the positive electrode material layer. For example, one or both ends located on the elongated side (before winding) of the positive electrode current collector may have a part where the positive electrode material layer is not provided on either side such that a “current collector extending part” described later is provided.

The negative electrode 2 includes at least a negative electrode material layer 22 and a negative electrode current collector 21 (see FIG. 5). For the negative electrode 2, the negative electrode material layer is provided on at least one side of the negative electrode current collector, and the negative electrode material layer includes a negative electrode active material as an electrode active material. For example, for the negative electrode in the electrode wound body, the negative electrode material layer may be provided on both sides of the negative electrode current collector, or may be provided only on one side of the negative electrode current collector. The negative electrode current collector does not necessarily have to have, on both sides thereof or on the whole surface of one side thereof, the negative electrode material layer. For example, one or both ends located on the elongated side (before winding) of the negative electrode current collector may have a part where the negative electrode material layer is not provided on either side such that a “current collector extending part” is provided.

The electrode active materials included in the positive electrode 1 and the negative electrode 2, that is, the positive electrode active material and the negative electrode active material are substances directly involved in the transfer of electrons in the secondary battery, and are main substances of the positive and negative electrodes, which are responsible for charge-discharge, that is, a battery reaction. More specifically, ions are brought into the electrolyte due to “the positive electrode active material included in the positive electrode material layer” and “the negative electrode active material included in the negative electrode material layer”, and such ions move between the positive electrode 1 and the negative electrode 2 to transfer electrons, thereby leading to charge-discharge. The positive electrode material layer and the negative electrode material layer may be layers particularly capable of occluding and releasing lithium ions. More specifically, the secondary battery according to the present disclosure may be a non-aqueous electrolyte secondary battery in which lithium ions move between the positive electrode 1 and the negative electrode 2 through a non-aqueous electrolyte to charge and discharge the battery. When lithium ions are involved in charge-discharge, the secondary battery according to the present disclosure corresponds to a so-called “lithium ion battery”, and the positive electrode 1 and the negative electrode 2 include a layer capable of occluding and releasing lithium ions.

When the positive electrode active material of the positive electrode material layer is composed of, for example, a granular material, a binder may be included in the positive electrode material layer for more sufficient contact between the particles and shape retention. Furthermore, a conductive aid may be included in the positive electrode material layer to facilitate the transfer of electrons that promote a battery reaction. Similarly, when the negative electrode active material of the negative electrode material layer is composed of, for example, a granular material, a binder may be included for more sufficient contact between the particles and shape retention therein, and a conductive aid may be included in the negative electrode material layer to facilitate the transfer of electrons that promote a battery reaction. The positive electrode material layer and the negative electrode material layer can be respectively referred to also as a “positive electrode mixture layer” and a “negative electrode mixture layer”, because multiple components are contained therein described above.

The positive electrode active material may be a material that contributes to occlusion and release of lithium ions. From such a viewpoint, the positive electrode active material may be, for example, a lithium-containing composite oxide. More specifically, the positive electrode active material may be a lithium-transition metal composite oxide containing lithium and at least one transition metal selected from the group consisting of cobalt, nickel, manganese, and iron. More specifically, in the positive electrode material layer of the secondary battery according to the present disclosure, such a lithium-transition metal composite oxide may be preferably included as a positive electrode active material. For example, the positive electrode active material may be a lithium cobaltate, a lithium nickelate, a lithium manganate, a lithium iron phosphate, or a material obtained by replacing a part of the transition metal thereof with another metal. Such positive electrode active materials may be included as a single species, or two or more species thereof may be included in combination.

The binder that can be included in the positive electrode material layer is not particularly limited. Examples of the binder in the positive electrode material layer can include at least one selected from the group consisting of a polyvinylidene fluoride, a vinylidene fluoride-hexafluoropropylene copolymer, a vinylidene fluoride-tetrafluoroethylene copolymer, and a polytetrafluoroethylene.

The conductive aid that can be included in the positive electrode material layer is not particularly limited. Examples of the conductive aid in the positive electrode active material layer include at least one selected from the group consisting of carbon blacks such as thermal black, furnace black, channel black, ketjen black, and acetylene black; graphite; carbon fibers such as carbon nanotubes and vapor phase growth carbon fibers; metal powders such as copper, nickel, aluminum, and silver, and polyphenylene derivatives, and the like.

The negative electrode active material may be a material that contributes to occlusion and release of lithium ions. From such a viewpoint, the negative electrode active material may be, for example, various carbon materials, oxides, and/or lithium alloys.

Examples of the various carbon materials for the negative electrode active material can include graphite (for example, natural graphite and/or artificial graphite), hard carbon, soft carbon, and/or diamond-like carbon. In particular, graphite is high in electron conductivity and is excellent in adhesiveness to the negative electrode current collector. Examples of the oxides for the negative electrode active material include at least one selected from the group consisting of a silicon oxide, a tin oxide, an indium oxide, a zinc oxide, and a lithium oxide. The lithium alloys for the negative electrode active material may be any metal that can be alloyed with lithium, and may be, for example, a binary, ternary, or higher alloy of lithium and a metal such as Al, Si, Pb, Sn, In, Bi, Ag, Ba, Ca, Hg, Pd, Pt, Te, Zn, and/or La. Such an oxide may be, for example, amorphous as its structural form. This is because deterioration due to nonuniformity such as crystal grain boundaries or defects is less likely to be caused.

The binder that can be included in the negative electrode material layer is not particularly limited. Examples of the binder in the negative electrode material layer can include at least one selected from the group consisting of a styrene-butadiene rubber, a polyacrylic acid, a polyvinylidene fluoride, a polyimide resin, and a polyamideimide resin.

The conductive aid that can be included in the negative electrode material layer is not particularly limited. Examples of the conductive aid in the negative electrode active material layer include at least one selected from the group consisting of carbon blacks such as thermal black, furnace black, channel black, ketjen black, and acetylene black; graphite; carbon fibers such as carbon nanotubes and vapor phase growth carbon fibers; metal powders such as copper, nickel, aluminum, and silver, and polyphenylene derivatives, and the like. It is to be noted that the negative electrode material layer may include therein a component derived from a thickener component (for example, a carboxymethyl cellulose) used at the time of manufacturing the battery.

The positive electrode current collector and negative electrode current collector for use in the positive electrode and the negative electrode are members that contribute to collecting and supplying electrons generated in the active materials due to the battery reaction. Such a current collector may be a metal member in a sheet form, and may have a porous or perforated form. For example, the current collector may be a metal foil, a punching metal, a net, and/or an expanded metal. The positive electrode current collector that is used for the positive electrode may be made of a metal foil containing at least one selected from the group consisting of aluminum, stainless steel, nickel, and the like. The positive electrode current collector may be, for example, an aluminum foil. In contrast, the negative electrode current collector that is used for the negative electrode may be made of a metal foil containing at least one selected from the group consisting of copper, stainless steel, nickel, and the like. The negative electrode current collector may be, for example, a copper foil.

The separator for use between the positive electrode and the negative electrode is a member provided from viewpoints such as preventing a short circuit due to contact between the positive and negative electrodes and holding the electrolyte. In other words, the separator can be considered as a member that allows ions to pass while preventing electric contact between the positive electrode and the negative electrode. For example, the separator is a porous or microporous insulating member, which has the form of a membrane due to the small thickness. By way of example only, a microporous membrane made of a polyolefin may be used as the separator. In this respect, the microporous membrane for use as the separator may include, for example, only a polyethylene (PE) or only a polypropylene (PP) as the polyolefin. Furthermore, the separator may be a laminate composed of a “microporous membrane made of PE” and a “microporous membrane made of PP”.

The surface of the separator may be covered with an inorganic particle coat layer, an adhesive layer, or the like. The surface of the separator may have adhesiveness. It is to be noted that the separator should not be particularly limited by its name in the present disclosure. For example, the separator may be a solid electrolyte, a gel-like electrolyte, insulating inorganic particles, and the like that have a similar function.

For the secondary battery according to the present disclosure, the electrode wound body composed of the electrode-constituting layer including the positive electrode, the negative electrode, and the separator is enclosed together with an electrolyte in an exterior body. When the positive electrode and the negative electrode include a layer capable of occluding and releasing lithium ions, the electrolyte may be “a non-aqueous” electrolyte such as an organic electrolyte and an organic solvent. More specifically, the electrolyte may be a non-aqueous electrolyte. In the electrolyte, metal ions released from the electrodes (positive electrode and/or negative electrode) will be present, and the electrolyte will thus assist the movement of metal ions in the battery reaction.

The non-aqueous electrolyte is an electrolyte including a solvent and a solute. A specific solvent for the non-aqueous electrolyte may contain at least a carbonate. Such a carbonate may be cyclic carbonates and/or chain carbonates. Although not particularly limited, examples of the cyclic carbonates include at least one selected from the group consisting of a propylene carbonate (PC), an ethylene carbonate (EC), a butylene carbonate (BC), and a vinylene carbonate (VC).

Examples of the chain carbonates include at least one selected from the group consisting of a dimethyl carbonate (DMC), a diethyl carbonate (DEC), an ethyl methyl carbonate (EMC), and a dipropyl carbonate (DPC). By way of example only, combinations of cyclic carbonates and chain carbonates may be used as the non-aqueous electrolyte, and for example, a mixture of an ethylene carbonate and a diethyl carbonate may be used. The solute of the non-aqueous electrolyte can be a common solute. As a specific solute for the non-aqueous electrolyte, for example, Li salts such as LiPF₆ and/or LiBF₄ may be used.

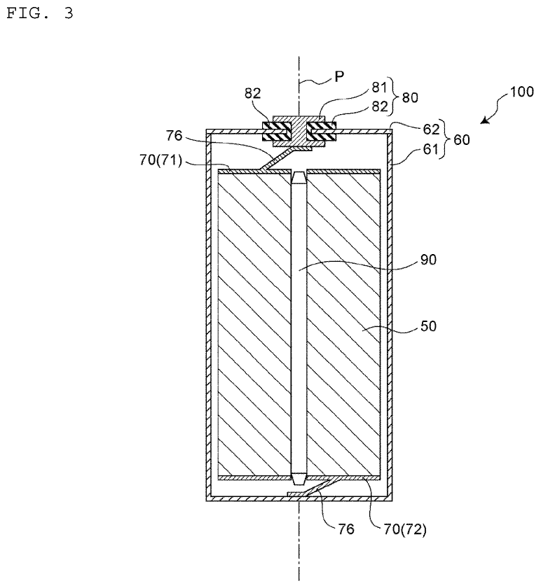

FIG. 2 is a schematic perspective view illustrating an appearance of an example of a secondary battery 100 according to the present disclosure. An exterior body 60 that houses the electrode wound body may be a hard case, and may include members such as the main body 61 and the lid 62. For example, the main body 61 may be a cup-shaped member including the side surface of the exterior body 60 and a main surface (typically, for example, a bottom or lower surface) that is continuous with the side surface. The lid 62 part may be a member combined so as to cover the cup-shaped main body 61 (preferably, provided so as to shield the hollow inside the main body 61 from the outside). In a case where the exterior body 60 includes the main body 61 and the lid 62, the main body 61 and the lid 62 are sealed after the electrode wound body, the electrolyte, and electrode terminals and the like if desired are housed. The method for sealing the exterior body 60 is not particularly limited, and examples thereof include a laser irradiation method.

As a material constituting the main body 61 and the lid 62, any material that can constitute a hard case type exterior body in the field of secondary batteries can be used. Such a material may be a conductive material in which electron transfer can be achieved or an insulating material in which no electron transfer can be achieved. The material of the exterior body is preferably a conductive material from the viewpoint of electrode extraction.

Examples of the conductive material include conductive materials such as silver, gold, copper, iron, tin, platinum, aluminum, nickel, and/or stainless steel. Examples of the insulating material include insulating polymer materials such as polyesters (such as polyethylene terephthalate), polyimides, polyamides, polyamide-imides, and/or polyolefins (such as polyethylene and/or polypropylene).

From the viewpoint of conductivity and rigidity, both the main body and the lid may be made of stainless steel. It is to be noted that as defined in “JIS G 0203 Glossary of terms used in iron and steel”, stainless steel refers to alloy steel containing chromium or chromium and nickel, and generally refers to steel in which the chromium content is about 10.5% or more of the whole. Examples of such stainless steel include martensitic stainless steel, ferritic stainless steel, austenitic stainless steel, austenitic ferritic stainless steel, and/or precipitation hardening stainless steel.

The dimensions of the main body and lid of the exterior body are determined mainly depending on the dimensions of the electrode wound body. For example, the exterior body may have dimensions such that the movement of the electrode wound body in the exterior body is prevented when the electrode wound body is housed. Preventing the movement of the electrode wound body makes it possible to prevent the electrode wound body from being damaged by an impact or the like and improve the stability of the secondary battery.

The exterior body may be a flexible case such as a pouch made of a laminate film. The laminate film may have a configuration where at least a metal layer (for example, aluminum or the like) and an adhesive layer (for example, polypropylene and/or polyethylene, or the like) are laminated, or a configuration where a protective layer (for example, nylon and/or polyamide, or the like) is additionally laminated.

The thickness dimension (that is, the wall thickness dimension) of the exterior body is not to be considered particularly limited, but may be 10 μm or more and 200 μm or less, and for example, 50 μm or more and 100 μm or less. The average value of measured values at any ten points is used for the thickness dimension of the exterior body.

The secondary battery is typically provided with external terminals. As such electrode terminals, for example, an electrode terminal for the positive electrode and an electrode terminal for the negative electrode may be provided on different surfaces of the exterior body. More specifically, electrode terminals for the positive electrode and the negative electrode may be respectively provided at exterior body ends that face each other in the winding axis direction of the electrode wound body.

For the electrode terminals, materials with high conductivity may be used. The materials of the electrode terminals are not to be considered particularly limited, and examples thereof can include at least one selected from the group consisting of silver, gold, copper, iron, tin, platinum, aluminum, nickel, and stainless steel.

The electrode terminals are not particularly limited, and may have any configuration. For example, the electrode terminal may be made of a single material, or may be made of multiple materials. The electrode terminal (hereinafter, referred to also as an “electrode terminal structure”) made of multiple materials may include, for example, a rivet part, an inner terminal, and/or a gasket part.

The rivet part and the inner terminal may be made of a material that can achieve electron transfer. For example, the rivet part and the inner terminal are each made of a conductive material such as silver, gold, copper, iron, tin, platinum, aluminum, nickel, and/or stainless steel. The gasket part may be made of an insulating material. For example, the gasket part is made of an insulating polymer material such as a polyester (for example, polyethylene terephthalate), a polyimide, a polyamide, a polyamide-imide, and/or a polyolefin (for example, polyethylene and/or polypropylene).

The electrode terminal structure is not particularly limited, and for example, may be fitted and inserted in an opening of the exterior body. The electrode terminal structure may include a rivet part for mainly leading the electrode to the outside, an outer gasket part for preventing electrolyte leakage while ensuring electrical insulation between the rivet part and the exterior body, an inner terminal for ensuring an electrical connection between the rivet part and the electrode wound body, and an inner gasket part for preventing electrolyte leakage while ensuring electrical insulation between the inner terminal and the exterior body.

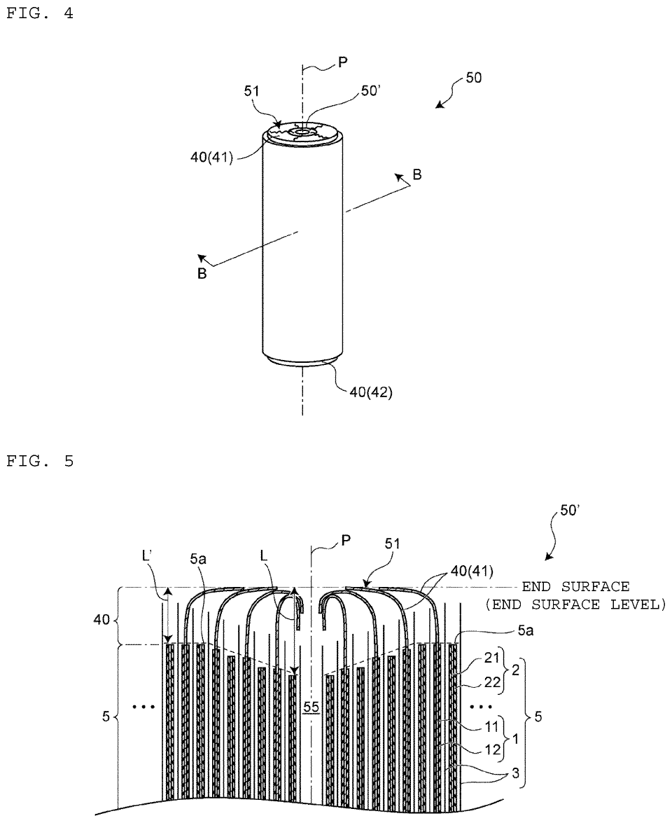

FIG. 2 is a schematic perspective view illustrating an appearance of an example of a secondary battery 100 according to the present disclosure. In addition, FIG. 4 is a schematic perspective view illustrating an appearance of an example of the electrode wound body 50 constituting the secondary battery according to the present disclosure. In the drawing, the secondary battery 100 and the electrode wound body 50 have, but are not necessarily limited to, a substantially cylindrical shape. For example, the electrode wound body 50 may have a substantially elliptic cylindrical shape. More specifically, the sectional-view shape of the electrode wound body 50 viewed from the direction along the winding axis is not particularly limited, and can be, for example, a substantially circular shape, a substantially elliptical shape, a substantially angular shape, or the like. In the present specification, the substantially angular shape encompasses a shape with chamfered or rounded corners or nooks, regardless of the accuracy of corners or surfaces in the shape.

FIG. 3 is a schematic sectional view of the secondary battery in FIG. 2 in a section passing through the winding axis P along a line A-A as viewed in the arrow direction. The electrode wound body 50 housed in the exterior body includes a central cavity 55 (see FIG. 5) extending at the center along the winding axis. In other words, according to an embodiment of the present disclosure, the electrode-constituting layer 5 (see FIG. 5) may be wound such that a hollow is provided at the winding center. The central cavity 55 may have a substantially cylindrical shape elongated in the direction of the winding axis P. The shape of the central cavity 55 in plan view may be, for example, a substantially circular shape with a predetermined inner diameter from the winding axis P substantially at the center, or a substantially elliptical shape. As illustrated in FIG. 3, for example, a center pin 90 may be inserted into the central cavity 55.

The center pin 90 may be opened at both ends in the direction of the winding axis P, and may have a length extending from one end of the electrode wound body 50 to the other end thereof. The sectional shape of the center pin 90 in plan view is not particularly limited, and may have, for example, a substantially circular shape, a substantially elliptical shape, or a substantially C-shape. The diameter of the center pin 90 may be constant in the winding axis direction or may have a tapered shape at least at one end in the axial direction. The material of the center pin 90 is not particularly limited, but examples thereof can include at least one selected from the group consisting of copper, iron, aluminum, nickel, titanium, and stainless steel.

The center pin 90 inserted through the winding center of the electrode wound body 50 contributes to improved safety of the secondary battery. Specifically, the electrode wound body 50 can be kept from undergoing deformation caused by electrode expansion due to external impact or repeated charging-discharge. Furthermore, when gas is generated inside the secondary battery, discharging the gas in the winding axis direction through the opening at the end of the center pin 90 can keep the secondary battery from undergoing deformation and rupture.

As illustrated in FIG. 3, the secondary battery according to the present disclosure may further include current collecting plates 70 (71, 72) that electrically connects one of an electrode terminal 81 and the exterior body 60 to the electrode wound body 50. As illustrated, the current collecting plate 70 may be electrically connected to at least a part of an end surface of the electrode wound body 50. In other words, the current collecting plate 70 may be combined with the electrode wound body 50 so as to cover at least a part of the end surface of the electrode wound body 50. More specifically, the positive electrode and negative electrode constituting the electrode wound body 50 may be each electrically connected to the electrode terminal 81 or the exterior body 60 via the current collecting plate 70 connected to at least a part of the end surface of the electrode wound body 50. More specifically, the collecting plates 70 of the positive and negative electrodes may be electrically led out to the outside via the electrode terminal 81 and/or the exterior body 60.

The current collecting plates 70 may be made of a material that can achieve electron transfer. For example, the current collecting plate 70 may be made of a conductive material such as silver, gold, copper, iron, tin, platinum, aluminum, nickel, and/or stainless steel. The forms of the current collecting plates are not particularly limited, and may be, for example, a band shape, a flat plate shape, or a substantially disk shape. In addition, as illustrated in FIG. 3, the current collecting plate 70 may include an elongated part 76 for connection to the electrode terminal 81 and/or the exterior body 60. The elongated part 76 may be configured as an integrated member with the current collecting plate 70. By being configured as an integrated member, the step of connecting the elongated part 76 and the current collecting plate in the assembly of the secondary battery can be omitted.

FIG. 4 is a schematic perspective view of the electrode wound body 50 of the secondary battery according to an embodiment of the present disclosure. FIG. 5 is a schematic sectional enlarged view of the electrode wound body 50 in the vicinity of the center 50′ thereof in FIG. 4 in a section passing through the winding axis P along a line B-B as viewed in the arrow direction. As illustrated in FIG. 5, the secondary battery according to the present disclosure includes the electrode-constituting layer 5 including the positive electrode 1, the negative electrode 2, and the separator 3 disposed between the positive electrode 1 and the negative electrode 2, and typically further includes an electrolyte (not illustrated). In addition, in the electrode wound body 50 of the secondary battery according to an embodiment of the present disclosure, at least one electrode of the positive electrode 1 and the negative electrode 2 has a current collector extending part 40. The “current collector extending part” in the present disclosure means a part of the electrode where the current collector without any electrode material layer extends from an end side of the electrode. In other words, the “current collector extending part” may be an exposed part (preferably, a part provided with no electrode material layer) of the current collector extending from any one of end sides constituting the end surface of the electrode wound body. As described already, in the secondary battery according to the present disclosure, the positive electrode and/or the negative electrode may have a current collector of a metal foil. Accordingly, the “current collector extending part” can be referred to also as a “current collector exposed part”, a “current collecting foil extending part”, or the like.

The secondary battery according to an embodiment of the present disclosure includes the current collector extending part 40 of either one of the positive electrode 1 and negative electrode 2 at the end of the electrode wound body 50. More specifically, at the end of the electrode wound body 50, any one electrode of the positive electrode 1 and the negative electrode 2 has the current collector extending part 40 where the current collector extends outward from the other electrode. In this regard, the “outward” means the outer side of the electrode wound body 50 in the direction of the winding axis P. More specifically, the secondary battery according to the present disclosure includes any one of a positive electrode current collector extending part 41 extending longer than the negative electrode 2 in the direction of the winding axis P and a negative electrode current collector extending part 42 extending longer than the positive electrode 1. In addition, according to an embodiment, the electrode wound body 50 may include both the positive electrode current collector extending part 41 and the negative electrode current collector extending part 42, and the positive electrode current collector extending part 41 and the negative electrode current collector extending part 42 may extend at mutually different ends in the electrode wound body 50. More specifically, the positive electrode current collector extending part 41 and the negative electrode current collector extending part 42 may extend in directions that are directed opposite to each other in the direction of the winding axis P.

As illustrated in FIG. 5, at least a part of the current collector extending part 40 may have substantially linear shape in a sectional view passing through the winding axis P. In this regard, the “substantially linear shape” is not limited to a linear shape, and includes a shape in which the current collector extending part is continuously bent at a slight angle (interior angle close to 180°) as illustrated in FIG. 5. For example, the “substantially linear shape” includes a continuously bent shape at an interior angle of about 150° or greater, or about 160° or greater. As illustrated in FIG. 5, according to an embodiment of the present disclosure, the current collector extending part 40 may extend substantially linearly and bend in the vicinity of an end surface 51. At least a part of the bent current collector extending part 40 may be exposed at the end surface 51 of the electrode wound body. In other words, the end surface 51 of the electrode wound body may be constituted by at least a part of the bent current collector extending part 40. More specifically, at least a part of the current collector extending part 40 may be bent so as to provide a substantially flat surface substantially perpendicular to the winding axis P at the end surface 51 of the electrode wound body. With the substantially flat surface formed at the end surface 51 of the electrode wound body, the current collecting plate 70 (see FIG. 3) and the end surface 51 of the electrode wound body can be connected in a larger connection area. In this regard, the “substantially flat surface” in the present specification means, in short, a flat surface in a macroscopic view. More specifically, the term encompasses, in the case of a microscopic view, a shape with minute irregularities or a case with minute distortion in whole or in part, rather than a flat surface in a physically strict sense.

In the present disclosure, “bending” encompasses at least curving and/or bending. The curving is, in a macroscopic view, curving in a bay shape (or arcuate shape) (that is, bending in a substantially curvaceous manner), which means a rounded curve, and also encompasses a flexure. The bending is bending in an acute angle or in an angular form in a sectional view (that is, bending in a substantially linear manner). In the secondary battery of the present disclosure, the current collector extending part 40 may have a wave shape with multiple bent shapes repeated. More specifically, in a sectional view passing through the winding axis P, the current collector extending part 40 may extend so as to meander due to the bent shapes.

The current collector extending part 40 located in the vicinity of the central cavity 55 may be bent toward the winding center of the electrode wound body 50. In addition, the current collector extending part 40 positioned in the vicinity of the central cavity 55 may have a larger curvature than the current collector extending part 40 positioned on the outer peripheral side of the electrode wound body 50. Specifically, the current collector extending part 40 may be bent so as to be folded back toward the central cavity 55 in the vicinity of the central cavity 55. More specifically, in the vicinity of the central cavity 55, the current collector extending part 40 may extend in the direction of the winding axis P from the end surface 51 of the electrode wound body, and have a shape bent toward the inner peripheral side, and then bent toward the internal side of the electrode wound body 50. The end of the current collector extending part 40 bent toward the internal side may be located in the central cavity 55. More specifically, the inner side surface (that is, the inner wall surface) of the central cavity 55 located on the side close to the end surface 51 of the electrode wound body may be formed by the folded current collector extending part 40. In particular, the current collector extending part 40 closest to the central cavity 55 may be greatly bent so as to form a shape protruding toward the end surface 51 of the electrode wound body. More specifically, the tip of the current collector extending part 40 close to the central cavity 55 can be disposed on the internal side than the tip of the current collector extending part 40 on the outer peripheral side.

With such a shape, the current collector extending part 40 can assist maintaining the shape of the opening portion of the central cavity 55 in the end surface 51 of the electrode wound body. The opening of the central cavity 55 may be defined by the inwardly bent current collector extending part 40 at the end surface 51 of the electrode wound body. Such a bent shape can be referred to also as, for example, a “folded shape”, a “substantially U-shape (or substantially V-shape)”, a “curved shape with a maximum point”, a “shape bent at an acute angle”, or the like. When the opening of the central cavity 55 is formed by the current collector extending part 40 bent so as to be folded back, the density of the current collector extending part 40 in the opening can be further increased in the sectional view shown in FIG. 5. Thus, the opening of the central cavity 55 can be prevented in a more preferred manner from undergoing deformation due to external impact or the like.

Furthermore, in the sectional view, the electrode-constituting layer 5 including the positive electrode 1, the negative electrode 2, and the separator 3 may be shifted toward one end in the direction of the winding axis P in the vicinity of the central cavity 55. Specifically, in the vicinity of the central cavity 55, the electrode-constituting layer 5 may have a structure shifted to the internal side from the end surface 51 of the electrode wound body in the sectional view. In this regard, the “shifted structure” in the present specification means a structure in which the position of the end side of the electrode-constituting layer 5 is varied in the direction of the winding axis P. In the-sectional view passing through the winding axis P, at least one end of the electrode-constituting layer 5 located in the vicinity of the central cavity 55 may be disposed closer to the internal side of the battery than an end of the electrode-constituting layer 5 located closer to the outer peripheral side.

The “internal side” in the present specification means the inside of the electrode wound body 50 in the direction of the winding axis P. For example, as illustrated in FIG. 5, the electrode-constituting layer 5 located on the innermost periphery of the electrode wound body 50 may be positioned to be shifted toward the internal side (that is, in the downward direction in FIG. 5) from the electrode-constituting layer 5 located on the outer peripheral side. In addition, the internal side can also be considered as the side closer to central cavity 55 extending at the center along the winding axis P of the electrode wound body 50. In other words, the electrode-constituting layer 5 located on the outer peripheral side of the electrode wound body 50 may be disposed closer to the end surface side (that is, in the upward direction in FIG. 5) than the electrode-constituting layer 5 located in the vicinity of the central cavity 55. This means that the electrode-constituting layer 5 located on the outer peripheral side is shifted toward the end surface 51 with respect to the electrode-constituting layer 5 located at the innermost periphery of the electrode wound body 50.

The “shift” of the electrode-constituting layer 5 as described above can separate the tip of the current collector extending part 40 folded back toward the central cavity 55 from the electrode-constituting layer 5. Specifically, the electrode-constituting layer 5 has a “shift” toward the internal side of the electrode wound body 50, thereby allowing the length dimension (that is, the length dimension along the winding axis P) of the current collector extending part 40 extending substantially linearly along the winding axis P in the sectional view to be secured to be longer. Thus, the distance between any one of the positive and negative electrodes including the current collector extending part 40 and the other electrode included in the electrode-constituting layer 5 can be more suitably secured in the vicinity of the central cavity 55. Thus, the secondary battery according to the present disclosure can be more suitably prevented from causing a short circuit in the electrode wound body.

In this regard, the “vicinity of the central cavity” may be, in plan view, 0% or more (excluding 0%) and 30% or less, and can be located, for example, at a distance of 0% or more (excluding 0%) and 20% or less, with respect to the diameter of the electrode wound body 50. It is to be noted that the above-described range can be changed appropriately depending on the size of the electrode wound body, the diameter of the central cavity, and/or the thicknesses of the positive and negative electrodes and separator. By way of example only, the “vicinity of the central cavity” may be located at a radial distance from the outer periphery of the central cavity in the range of 0 mm or more (excluding 0 mm) of about 3 mm or less, or 0 mm or more (excluding 0 mm) of about 2 mm or less in plan view.

In the secondary battery according to an embodiment of the present disclosure, any one of the positive electrode and the negative electrode may include the current collector extending part 40, whereas the other electrode may be an electrode disposed at the innermost periphery of the electrode wound body 50. More specifically, the electrode including the current collector extending part 40 and the electrode positioned at the innermost periphery of the electrode wound body 50 may be different electrodes from each other at any one end surface of the electrode wound body 50. For example, as illustrated in FIG. 5, the electrode located at the innermost periphery may be the negative electrode 2 according to an embodiment in which the positive electrode 1 includes the current collector extending part 40 at the end surface 51 of the electrode wound body 50. The electrode located at the innermost periphery and the current collector extending part 40 are separated from each other by the above-described shift of the electrode-constituting layer 5, and thus, conduction between the different electrodes can be more suitably prevented.

Furthermore, as will be described later, the degree of the shift of the electrode-constituting layer 5 toward the internal side can be the largest at the innermost periphery of the electrode wound body 50. In such an electrode wound body, when the electrode positioned at the innermost periphery and the electrode including the current collector extending part 40 are different electrodes from each other, the distance between the positive and negative electrodes in the vicinity of the central cavity 55 can be secured to be longer. Accordingly, the positive electrode and the negative electrode at the innermost periphery are suitably separated from each other, and a short circuit in the electrode wound body can be more suitably prevented from being caused.

According to an embodiment of the present disclosure, in the sectional view passing through the winding axis P, the distance L between the end side of the electrode including no current collector extending part 40 and the end surface 51 of the electrode wound body in the vicinity of the central cavity 55 of the electrode wound body is different from the distance L′ at the outer peripheral side of the electrode wound body. More specifically, at the end surface 51 where one of the positive and negative electrodes has the current collector extending part 40, the distance between the end surface 51 and the other electrode in the vicinity of the central cavity 55 have different distances from each other at the inner peripheral side and outer peripheral side of the electrode wound body 50. More specifically, in the vicinity of the central cavity 55, the distance L between the end side of the electrode including no current collector extending part 40, of the positive electrode and the negative electrode, and the end surface 51 of the electrode wound body may be relatively longer than the distance L′ at the outer peripheral side of the electrode wound body 50.

As described above, in the present disclosure, the end surface 51 of the electrode wound body may be a substantially flat surface formed by the bent current collector extending part 40. Thus, as illustrated in FIG. 5, the “end surface” referred to herein can also be understood as an “end surface level” that is a virtual straight line connecting the exposed parts of the bent current collector extending part 40 at the end surface 51 of the electrode wound body. For example, as illustrated in FIG. 5, when the positive electrode 1 has the current collecting foil extending part 40, the distance L from the end surface level 51 to the end side of the negative electrode 2 in the vicinity of the central cavity 55 may be longer than the distance L′ at the outer peripheral side of the electrode wound body 50. More specifically, the end surface 51 (or the end surface level) of the electrode wound body and the electrode including no current collector extending part 40 on the side close to the end surface 51 may be separated more greatly in the vicinity of the central cavity 55. As described already, the current collector extending part 40 positioned in the vicinity of the central cavity 55 can be bent more greatly than the current collector extending part 40 positioned on the outer peripheral side of the electrode wound body 50 from the viewpoint of maintaining the shape of the central cavity 55. In the vicinity of the central cavity 55, when the electrode that is different from the electrode including the current collector extending part 40 has a structure disposed further away from the end surface 51, a short circuit can be more suitably prevented from being caused by the bent current collector extending part 40.

When the distance from the end surface 51 of the electrode wound body on the outermost peripheral side of the electrode wound body 50 to the end side of the electrode including the current collector extending part 40 and the distance on the innermost peripheral side are denoted respectively by L′ and L in the sectional view passing through the winding axis P, the distance L on the innermost peripheral side may fall within the range of about 1.05 times or more and about 3 times or less, for example, about 1.05 times or more and about 2 times or less, or about 1.05 times or more and about 1.5 times or less the distance L′ on the outermost peripheral side. It is to be noted that the above-described range can be changed appropriately depending on the length of the current collector extending part and/or the thicknesses of the positive and negative electrodes and separator.

In addition, according to an embodiment of the present disclosure, the distance from the end surface 51 of the electrode wound body to the electrode including no current collector extending part 40 is gradually decreased from the inner peripheral side of the electrode wound body 50 toward the outer peripheral side thereof. In other words, the distance between the electrode including the current collector extending part 40 and the end surface 51 of the electrode wound body may be gradually increased from the outer peripheral side of the electrode wound body 50 toward the central cavity 55. With such a structure, the tip of the current collector extending part 40 of any one electrode of the positive and negative electrodes and the other electrode can be more suitably separated from each other in the vicinity of the central cavity 55.

Furthermore, the distance between the end surface 51 of the electrode wound body and the end of the electrode is gradually changed, thereby allowing the positional shift from the adjacent electrode to be further reduced. Thus, the electrode reaction area in which the positive and negative electrodes face each other with the separator interposed therebetween can be secured to be larger. In addition, the part where the positive electrode material layer protrudes from the negative electrode material layer is further reduced, and thus, a short circuit and the like can be further kept from being caused by precipitation of metal lithium. As described above, the structure of the electrode wound body according to the present disclosure in which the end surface and the electrode end are gradually greatly separated from each other from the outer peripheral side toward the inner peripheral side can more suitably prevent a short circuit in the electrode wound body.

In the electrode wound body 50 constituting the secondary battery according to the present disclosure, the above-described electrode-constituting layer 5 may be shifted with an end contour 5a of the electrode-constituting layer inclined in the sectional view passing through the winding axis P. In this regard, the “end contour of the electrode-constituting layer” means a contour formed by an end side of a layer where the positive electrode 1 and the negative electrode 2 face each other with the separator 3 interposed therebetween in the sectional view passing through the winding axis P. More specifically, the end contour 5a of the electrode-constituting layer is a virtual contour line connecting multiple end sides of a layer where the positive electrode 1 and the negative electrode 2 face each other with the separator 3 interposed therebetween at one end surface of the electrode wound body. As illustrated in FIG. 5, in the sectional view passing through the winding axis P, the end contour 5a of the electrode-constituting layer may be inclined toward the internal side of the electrode wound body 50 with respect to the end surface 51 of the electrode wound body. In other words, the end contour 5a of the electrode-constituting layer may be inclined toward the central cavity 55 so as to be gradually separated from the end surface 51 at an angle with respect to the end surface 51 of the electrode wound body.

In this regard, the “inclination” means an aspect in which the angle formed by the end contour 5a with respect to the end surface 51 of the electrode wound body is not zero in absolute value. Furthermore, the inclination angle of the end contour 5a does not have to be constant as long as the end contour 5a has a shape gradually separated from the end surface toward the internal side. This means that the end contour of the electrode-constituting layer does not have to be a line uniformly inclined from the outermost periphery to the innermost periphery. More specifically, the end contour may be linear, bent and/or curved, and/or stepped.

In an embodiment of the present disclosure, the end contour of the electrode-constituting layer in the vicinity of the central cavity 55 is inclined at an angle that is different from that at which the end contour on the outer peripheral side is inclined. More specifically, the end contour in the vicinity of the central cavity 55 and the end contour on the outer peripheral side may have different inclination angles from each other with respect to the end surface 51 of the electrode wound body. Specifically, the inclination angle formed by the end contour of the electrode-constituting layer located in the vicinity of the central cavity 55 with respect to the end surface 51 of the electrode wound body is preferably an inclination angle that is larger than the end contour on the more outer peripheral side. Accordingly, in an embodiment of the present disclosure, the degree of the shift of the electrode-constituting layer 5 toward the internal side may be the largest in the vicinity of the central cavity 55.

As described already, the current collector extending part 40 positioned in the vicinity of the central cavity 55 may be bent more greatly than the current collector extending part 40 positioned on the outer peripheral side of the electrode wound body 50 from the viewpoint of maintaining the shape of the central cavity 55. In this case, the tip of the current collector extending part 40 positioned in the vicinity of the central cavity 55 can be disposed on the internal side of the electrode wound body 50, and thus needs to be sufficiently separated from the electrode-constituting layer 5. As described above, the electrode-constituting layer 5 has the end contour 5a inclined more in the vicinity of the central cavity 55, thereby allowing the tip of the bent current collector extending part 40 and the electrode-constituting layer 5 in the vicinity of the central cavity to be more suitably separated from each other.

Furthermore, the end contour 5a may be inclined toward the internal side with respect to the end surface 51 of the electrode wound body in the vicinity of the central cavity 55. For example, the electrode-constituting layer 5 may be disposed so as to be inclined only in the vicinity of the central cavity 55 and substantially parallel to the end surface 51 on the outer peripheral side. The inclination of the end contour 5a of the electrode-constituting layer only at a part of the end surface 51 makes it possible to secure a larger area in which the positive and negative electrodes face each other with the separator 3 interposed therebetween. Accordingly, the electrode reaction area of the electrode-constituting layer 5 can be secured to be larger, and the charge-discharge capacity of the secondary battery can be further improved. More specifically, the end contour 5a of the electrode-constituting layer is inclined in the vicinity of the central cavity 55, thereby allowing a short circuit to be more suitably prevented from being caused in the electrode wound body while further improving the performance of the secondary battery.

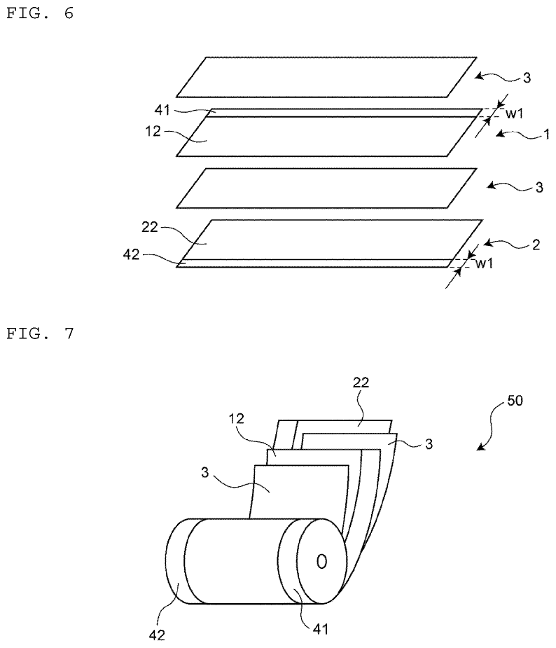

Next, a method for manufacturing the secondary battery according to the present disclosure will be described with reference to FIGS. 6 to 11. It is to be noted that the method described below considered by way of example only, and the method for manufacturing a secondary battery according to an embodiment of the present disclosure is not to be considered limited to the following method.

The secondary battery according to the present disclosure can be manufactured by a manufacturing method including the following steps. More specifically, a method for manufacturing the secondary battery according to the present disclosure includes a step of winding an electrode-constituting layer including a positive electrode, a negative electrode, and a separator disposed therebetween to form an electrode wound body with a central cavity left along the winding axis (electrode wound body forming step), a step of shaping an end of the electrode wound body including a current collector extending part (end surface shaping step), and a step of injecting an electrolyte into an exterior body while housing the electrode wound body in the exterior body (housing step).

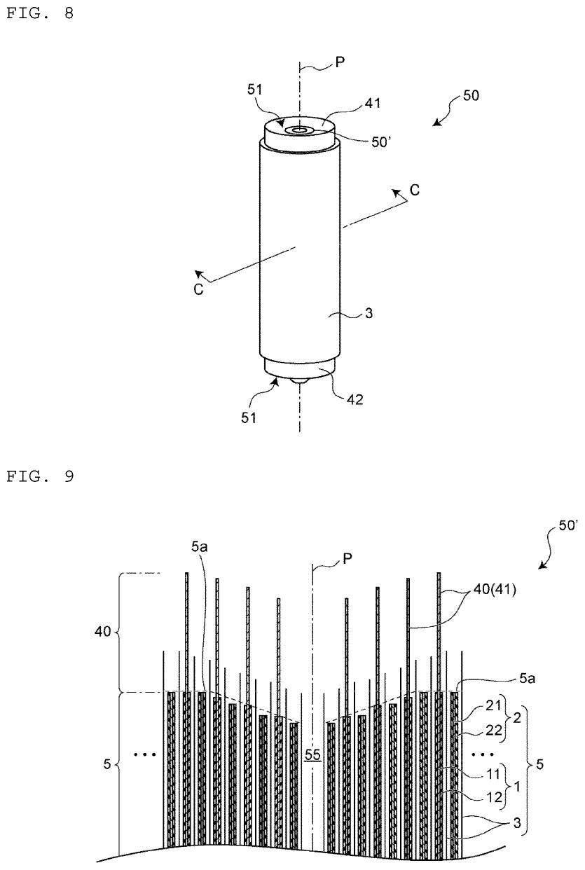

FIG. 6 is a schematic view for illustrating constituent members of an electrode wound body constituting a secondary battery according to an embodiment of the present disclosure. In addition, FIG. 7 is a schematic perspective view for illustrating a winding aspect of the electrode wound body 50 according to an embodiment of the present disclosure. In this step, the electrode wound body 50 is obtained by winding rectangular positive electrode 1, negative electrode 2, and separators 3 in a predetermined order so as to be overlapped with each other. Hereinafter, a step of forming an electrode wound body according to an embodiment of the present disclosure will be described.

In this step, first, the positive electrode 1, the negative electrode 2, and the two separators 3 are disposed in a predetermined order. As illustrated in FIG. 6, the positive electrode 1 or the negative electrode 2 has, at any one end side located on the elongated side (before winding), a positive electrode current collector extending part 41 or a negative electrode current collector extending part 42 where the current collector is exposed. In that regard, with the separator 3 stacked between the positive electrode 1 and the negative electrode 2, the electrodes are disposed in such a manner that the current collector extending part 40 of any one electrode of the positive electrode 1 and the negative electrode 2 extends outward from the other electrode. More specifically, the positive electrode material layer and the negative electrode material layer are stacked on one another so as to face each other with the separator 3 interposed therebetween, and disposed in such a manner that the positive electrode current collector extending part 41 extends at any one end side on the elongated side (before winding) of the electrode-constituting layer, whereas the negative electrode current collector extending part 42 extends at the other end side.

The length dimension w1 (see FIG. 6) of the current collector extending part in the winding axis direction is not particularly limited as long as a desired electrode wound body is obtained. For example, the length dimension w1 (in particular, the length dimension before winding or before end surface shaping described later) of the current collector extending part in the winding axis direction may be typically about 1 mm or more and about 20 mm or less, and may be, for example, about 2 mm or more and about 15 mm or less. The positive electrode current collector extending part 41 and the negative electrode current collector extending part 42 may each have the same length dimension w1, or may have different length dimensions w1.

Next, the electrode-constituting layer is wound around a winding core. At the time of winding, the electrode-constituting layer is wound so as to be shifted from the end surface with the current collector extending part to the inside of the electrode wound body in the vicinity of the winding core that forms the central cavity 55. In other words, for the winding from the vicinity of the winding core to the outer peripheral side, the electrode-constituting layer may be wound while shifting the position of the end side of the electrode-constituting layer toward the end surface with the current collector extending part. After the winding, the winding core is pulled out to form the central cavity 55 penetrating the electrode wound body along the winding axis P.

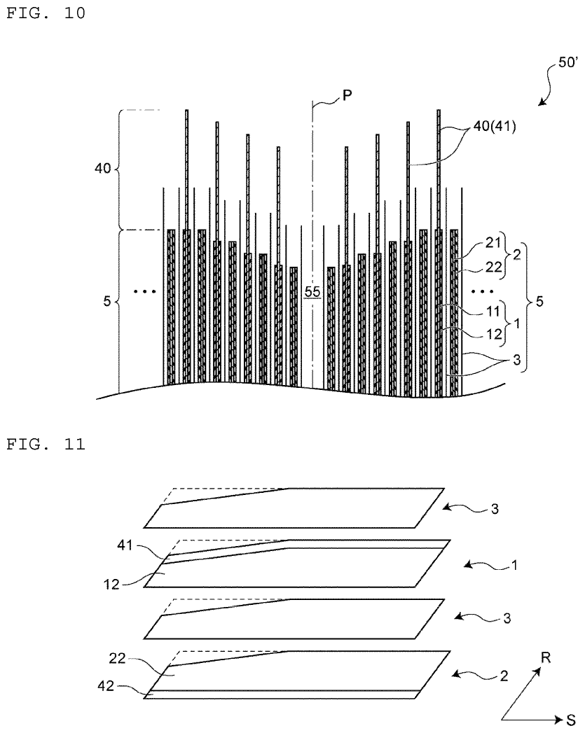

FIG. 8 is a schematic perspective view illustrating the electrode wound body 50 wound according to an embodiment of the present disclosure. In addition, FIG. 9 is a schematic sectional enlarged view of the electrode wound body 50 in the vicinity of the center 50′ thereof in FIG. 8 in a section passing through the winding axis P along a line C-C as viewed in the arrow direction. As illustrated in FIG. 8, one end surface 51 of the electrode wound body wound may have a recess shape in the vicinity of the winding axis P, and the other end surface 51 may have a protrusion shape in the vicinity of the winding axis P. In addition, as illustrated in FIG. 9, the positive electrode 1, the negative electrode 2, and the separator 3 each may be shifted toward the internal side of the electrode wound body 50 in the central cavity 55. As described above, winding the electrode-constituting layers in a shifted manner makes it possible to obtain an electrode wound body that has a structure in which the electrode-constituting layer 5 in the vicinity of the central cavity 55 is shifted toward the internal side. The formation of this shift further separates the current collector extending part 40 greatly folded back into the electrode wound body in the shaping step described later and the electrode-constituting layer 5 from each other, thereby allowing a short circuit in the electrode wound body to be more suitably prevented.

According to an embodiment of the present disclosure, the electrode-constituting layer is wound such that the end contour 5a (see FIG. 9) of the electrode-constituting layer at the end surface 51 including the current collector extending part 40 is inclined toward the internal side of the electrode wound body 50. More specifically, at the end surface 51 with the current collector extending part 40, the electrode-constituting layer may be wound while gradually shifting the electrode-constituting layer such that the end surface of the electrode wound body is recessed such that the inner peripheral part is recessed in a substantially conical shape from the outer peripheral part. Shifting the electrode-constituting layer such that the end contour 5a of the electrode-constituting layer is inclined can provide an electrode wound body that is capable of more suitably keeping a short circuit from being caused, while minimizing the positional shift from the adjacent electrode.

In addition, at the time of shifting the electrode-constituting layer, the electrode-constituting layer may be wound spirally at the end of the electrode wound body including the current collector extending part 40. More specifically, the electrode-constituting layer may be wound spirally so as to be gradually shifted in the direction of the winding axis, while causing the positive electrode 1 and the negative electrode 2 to face each other with the separator 3 interposed therebetween. More specifically, the electrode-constituting layer may be wound while gradually shifting the end of the electrode-constituting layer outward. FIG. 10 is a sectional enlarged view passing through the winding axis P, of a part of the electrode wound body obtained by spirally winding the electrode-constituting layer, in the vicinity of the center 50′ of the electrode wound body. As illustrated, in the spirally wound electrode wound body, the electrode-constituting layer 5 is shifted stepwise with the positive electrode 1 and the negative electrode 2 facing each other with the separator 3 interposed therebetween. More specifically, spirally winding allows the electrode-constituting layer 5 to be gradually shifted with the positive electrode 1 and the negative electrode 2 facing each other with the separator 3 interposed therebetween. Accordingly, the above-described method makes it possible obtain an electrode wound body capable of more suitably preventing a short circuit while maintaining a larger electrode reaction area.

In addition, according to an embodiment of the present disclosure, both the positive and negative electrodes can have the current collector extending part. According to such an embodiment, as illustrated in FIG. 7, the electrode-constituting layer may be wound with the positive electrode current collector extending part 41 extending outward from the negative electrode 2 and the separator 3, and the negative electrode current collector extending part 42 extending outward from the positive electrode and the separator 3. At the time of winding, the electrode-constituting layer may be wound while shifting the electrode-constituting layer in any one direction of the winding axis in the vicinity of the winding core. From the viewpoint of more suitably separating the positive and negative electrodes, the electrode-constituting layer may be wound such that the end surface with the current collector extending part, of the electrode disposed at the innermost periphery of the electrode wound body 50, has a protrusion shape projecting outward in the vicinity of the central cavity 55, whereas the other facing end surface has a recess shape recessed into the internal side.

The dimensions of the positive electrode 1, negative electrode 2, and separator 3 that can be used are not particularly limited as long as a desired electrode wound body is obtained. For example, the length dimension of the separators 3 in the longitudinal direction may be determined appropriately depending on the dimensions (particularly the number of windings of the electrode wound body) of the intended secondary battery.

In addition, in above-described the step of forming the electrode wound body, an electrode wound body with an electrode-constituting layer shifted may be obtained by using a positive electrode, a negative electrode, and/or a separator that differ in shape from the embodiment described above. In this regard, the “shape” of the positive electrode, negative electrode, and/or separator is the shape of the unwound electrode and/or separator in plan view, and is, for example, a shape in top view in the case of placement on a surface that has a maximum area.

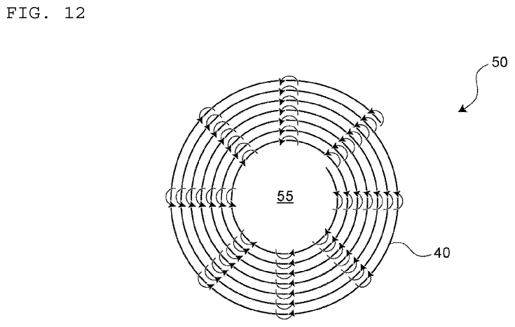

FIG. 11 is a schematic perspective view illustrating constituent members of an electrode wound body according to an embodiment of the present disclosure. Each of the positive electrode 1, the negative electrode 2, and the separator 3 may have a shape where any one of the end sides in the longitudinal direction S has at least a part inclined, with the length dimension in the widthwise direction R gradually increased in the longitudinal direction S. Any one of the positive and negative electrodes has a current collector extending part at the inclined end side. The other electrode may have a current collector extending part on the non-inclined end side. More specifically, the electrode material layers of the positive electrode 1 and negative electrode 2 may have a shape where the length dimension in the widthwise direction R is gradually increased in the longitudinal direction S.

At the time of winding, the positive electrode 1, the negative electrode 2, and the separator 3 are started to be wound from an end thereof with a relatively short length dimension in the widthwise direction R. More specifically, at one end of the electrode wound body, the length dimensions of the electrodes of the positive electrode 1 and negative electrode 2 in the winding axis direction are gradually increased in the winding direction. Accordingly, the obtained electrode wound body has a shape where a part where the electrode material layers of the positive electrode 1 and negative electrode 2 face each other with the separator 3 interposed therebetween is spirally shifted toward the inside of the electrode wound body at any one end surface of the electrode wound body. More specifically, the use of the constituent members where the end side has at least a part inclined allows a desired electrode wound body to be obtained without performing any operation for shifting the electrode-constituting layer being wound.

At least a part of the current collector extending part 40 is bent at the end surface 51 (see FIG. 8) of the electrode wound body obtained in the previous step to obtain a shaped end surface of the electrode wound body. The end surface of the electrode wound body 50 may be bent so as to fold the current collector extending part 40, such that the bent current collector extending part 40 will be kept from protruding outward from the outer periphery of the electrode wound body 50. In addition, for further strengthening the connection to the current collector in the subsequent step, the end surface of the electrode wound body may be shaped such that at least a part of the bent current collector extending part 40 forms, at the end surface, a substantially flat surface in a direction perpendicular to the winding axis. The bending may be performed, for example, by pressing the current collector extending part from the outside.

At the time of shaping, first, the current collector extending part in the vicinity of the central cavity is pressed from the outside. The current collector extending part in the vicinity of the central cavity may be, for maintaining the opening shape of the central cavity, separately pressed prior to pressing the current collector extending part on the outer peripheral side. The current collector extending part in the vicinity of the central cavity may be pressed to be folded to the inner peripheral side toward the central cavity. Then end of the current collector extending part may be bent toward the internal side of the electrode wound body 50 so as to follow the shape of the opening of the central cavity. More specifically, the current collector extending part may be, after being laid down toward the central cavity 55, bent so as to be folded back toward the internal side of the electrode wound body 50 along the central cavity 55 (see FIG. 5). Bending the current collector extending part in the vicinity of the central cavity as described above allows a substantially flat surface to be formed at the end surface of the electrode wound body while maintaining the shape of the central cavity.

Then, the current collector extending part located on the outer peripheral side is pressed. FIG. 12 is a schematic plan view for illustrating end face shaping according to an embodiment of the present disclosure. As illustrated, the current collector extending part 40 may be spirally pressed from the outer peripheral side of the electrode wound body 50 toward the inner peripheral side thereof in plan view. In accordance with such a pressing method, the current collector extending part can be laid down so as to be folded at the end surface to form a substantially flat surface in a direction perpendicular to the winding axis.

The step of forming the electrode wound body and the step of shaping the end surface make it possible to obtain the electrode wound body 50 in which the end contour 5a of the electrode-constituting layer is inclined to the internal side of the electrode wound body with respect to the end surface of the electrode wound body in the sectional view passing through the winding axis P as illustrated in FIG. 5. More specifically, in the electrode wound body 50 obtained by the steps described above, the end contour 5a of the electrode-constituting layer in the vicinity of the central cavity 55 is, at an angle with respect to the end surface of the electrode wound body, gradually separated from the end surface in the sectional view passing through the winding axis P. Thus, the current collector extending part 40 in the vicinity of the central cavity 55 can be folded back less than the current collector extending part 40 on the outer peripheral side. Accordingly, in the vicinity of the central cavity, the tip of the current collector extending part bent so as to be folded back can be more suitably separated from the electrode-constituting layer, and an electrode wound body capable of more suitably preventing a short circuit can be obtained.

The means for shaping the end surface of the electrode wound body is not particularly limited as long as a desired end surface is obtained. For example, the end surface may be shaped by pressing a pressing member against the end surface of the electrode wound body from the outside and moving the electrode wound body and/or the pressing member in a direction perpendicular to the winding axis. The structure, material, number of pressing members, or the like for the pressing member is not particularly limited as long as a desired end surface for the electrode wound body is obtained. Examples of the pressing member include a pressing roller and a pressing plate.

A current collecting plate is electrically connected to the end surface of the electrode wound body, shaped in the previous step. The current collecting plate may be attached so as to be joined to the flat surface formed at the end surface of the electrode wound body. As an example, the current collecting plate and the electrode wound body may be welded by a laser irradiation method. Irradiation with a laser from the current collecting plate side melts and alloys the current collecting plate and the current collector extending part immediately below the current collecting plate to achieve conduction.

While the electrode wound body with the current collecting plate attached thereto is housed in an exterior body, the current collecting plate is electrically connected to the electrode terminal or the exterior body, and an electrolytic solution is injected into the exterior body. Hereinafter, an aspect in a case where the exterior body includes a main body and a lid that is provided with an electrode terminal will be exemplarily described.

First, the lid, the electrode terminal, and an insulating member provided so as to fill the gap between the lid and the electrode terminal are bonded. Then, the elongated part extending from the current collecting plate is temporarily bent in advance toward the electrode terminal or the exterior body to adjust the shape, and then the elongated part is connected to the electrode terminal or the exterior body. Then, the main body and lid of the exterior body are bonded to each other. Finally, the electrolyte solution may be injected from an injection port (not illustrated) of the exterior body, and the injection port may be closed with a sealing plug (not illustrated). The bonding may be achieved by any method known in the field of secondary batteries, and for example, a laser irradiation method may be used.

### INDUSTRIAL APPLICABILITY

The secondary battery according to the present disclosure can be used in various fields in which power storage is assumed. By way of example only, the secondary battery according to the present disclosure the present disclosure can be used in the fields of electricity, information, and communication in which mobile devices and the like are used (such as the field of electric/electronic devices and the field of mobile devices including small electronic devices such as mobile phones, smartphones, notebook computers and digital cameras, activity trackers, arm computers, electronic paper, RFID tags, card-type electronic money, and smartwatches), home and small industrial applications (such as the fields of power tools, golf carts, and home, nursing, and industrial robots), large industrial applications (such as the fields of forklifts, elevators, and harbor cranes), the field of transportation systems (such as the fields of hybrid vehicles, electric vehicles, buses, trains, power-assisted bicycles, and electric two-wheeled vehicles), power system applications (such as the fields of various types of power generation, road conditioners, smart grids, and home power storage systems), medical applications (field of medical equipment such as earphone hearing aids), pharmaceutical applications (fields such as dosage management systems), IoT fields, space and deep sea applications (such as the fields of space probes and submersibles), and the like.

### DESCRIPTION OF REFERENCE SYMBOLS

1: Positive electrode
11: Positive electrode current collector
12: Positive electrode material layer
2: Negative electrode
21: Negative electrode current collector
22: Negative electrode material layer
3: Separator
40: Current collector extending part
41: Positive electrode current collector extending part
42: Negative electrode current collector extending part
5: Electrode-constituting layer
5a: End contour
50: Electrode wound body
51: End surface
55: Central cavity
60: Exterior body
61: Main body
62: Lid
70: Current collecting plate
76: Elongated part
80: Electrode terminal structure
81: Electrode terminal
82: Gasket part
90: Center pin
100: Secondary battery

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising
an electrode wound body that has an electrode-constituting layer wound, the electrode-constituting layer including a positive electrode, a negative electrode, and a separator disposed between the positive electrode and the negative electrode, wherein
the electrode wound body has a central cavity extending at a center along a winding axis,
one electrode of the positive electrode and the negative electrode includes, at an end surface of the electrode wound body, a current collector extending part where a current collector extends outward from another electrode, and
the current collector extending part near the central cavity is bent to be folded back toward the central cavity, and the electrode-constituting layer is shifted from the end surface to an internal side of the electrode wound body.

2. The secondary battery according to claim 1, wherein an electrode disposed at an innermost periphery of the electrode wound body is the other electrode.

3. The secondary battery according to claim 1, wherein a distance between the end surface and the other electrode near the central cavity is relatively longer than the distance on an outer peripheral side of the electrode wound body in a sectional view.

4. The secondary battery according to claim 3, wherein the distance is gradually decreased from an inner peripheral side of the electrode wound body toward the outer peripheral side.

5. The secondary battery according to claim 1, wherein an end contour of the electrode-constituting layer is inclined to the internal side with respect to the end surface in a sectional view.

6. The secondary battery according to claim 5, wherein the end contour near the central cavity and the end contour on an outer peripheral side have different inclination angles.

7. The secondary battery according to claim 1, wherein at least a part of the current collector extending part portion is bent at the end surface to form a flat surface perpendicular to a winding axis direction.

8. A method for manufacturing a secondary battery, comprising:
winding an electrode-constituting layer including a positive electrode, a negative electrode, and a separator disposed between the positive electrode and the negative electrode to form an electrode wound body while leaving a central cavity; and
shaping an end surface of the electrode wound body, wherein
forming the electrode wound body includes:
winding the electrode-constituting layer with a current collector extending part of one of the positive electrode and the negative electrode extending outward from another electrode at the end surface; and
winding the electrode-constituting layer such that the electrode-constituting layer is shifted from the end surface to an internal side of the electrode wound body near the central cavity, and
shaping the end surface of the electrode wound body includes bending the current collector extending part near the central cavity to be folded back.

9. The method for manufacturing a secondary battery according to claim 8, wherein an end contour of the electrode-constituting layer is inclined to the internal side by shifting of the electrode-constituting layer.

10. The method for manufacturing a secondary battery according to claim 8, wherein shifting is caused by spirally winding the electrode-constituting layer from the internal side toward the end surface.

11. The method of manufacturing a secondary battery according to claim 8, wherein shaping the end surface of the electrode wound body includes pressing the current collector extending part from outside to form a flat surface perpendicular to a winding axis direction.
